(19) United States
(12) Patent Application Publication
(10) Pub. No.: US 2018/0003211 A1
(43) Pub. Date: Jan. 4, 2018

(54) LIGHTWEIGHT FASTENER WITH THREADED WIRE NUT

(71) Applicant: SFS intec Holding AG, Heerbrugg (CH)

(72) Inventor: Sascha Costabel, Herrenberg (DE)

(73) Assignee: SFS intec Holding AG, Heerbrugg (CH)

(21) Appl. No.: 15/634,370

(22) Filed: Jun. 27, 2017

(30) Foreign Application Priority Data
Jun. 29, 2016 (DE) 102016111933.4

(51) Int. Cl. F16B 37/12; F16B 5/12

(52) U.S. Cl. CPC F16B 37/122; F16B 5/125

(57) ABSTRACT

A lightweight fastener includes a threaded body with at least one torque support, a housing, which receives the threaded body at least in part, and a counter support for at least one torque support. In accordance with the invention a wire nut or threaded wire nut is used as thread body. A lightweight fastener of this type is used in clips or inserts, i.e. fastening elements that are used in particular in the interior design of vehicles and aircraft.

### INCORPORATION BY REFERENCE

The following documents are incorporated herein by reference as if fully set forth: German Patent Application No. 102016111933.4, filed Jun. 29, 2016.

### BACKGROUND

The present invention relates to fastening devices which are referred to in the industry as clips or inserts. These belong to the group of lightweight fasteners and are used in vehicle construction and in the aviation industry.

In vehicle construction, as in the aeronautical industry, fastening elements are used, for example for claddings, and must satisfy specific requirements. In order to avoid processing steps that involve machining when it comes to the final assembly, planar elements for example are pre-drilled and are provided with clips or inserts prior to the final assembly, which clips or inserts have further screw elements or snap-fit retainers that are resilient or that are fitted with play. When it comes to the final assembly, the connectors to other cladding elements or structural supporting elements then engage in these screw elements or snap-fit retainers. The planar elements are in this case often partition wall elements or sandwich panels, which for weight-related reasons usually consist of two plastic outer layers which are adhesively bonded with a honeycomb-like reinforcement therebetween.

Clips can be embodied for example as double-limb retainers, as presented in DE 10 2015 009 643, which at the same time are resistant to rotation. Inserts are usually anchored as a whole in blind bores, resulting in a flush surface, and thus form an anchoring point.

### PRIOR ART

The clips presented in DE 10 2015 009 643 (see FIG. 1) have a design with a first limb 11 and a second limb 12. For assembly, the clip is slid onto a plate (merely indicated, 18), such that the fastening element 13 lies above a prepared opening in the plate (hidden in FIG. 1). This fastening element 13 has two lug protrusions 14, 15, which are each held in an associated cage or frame 16, 17. The frames are designed such that the fastening element 13 has lateral play, but cannot fall out from the clip. A fastener is guided through the plate (from below in FIG. 1) and thus allows the plate 18 to be connected to another element. This type of clip fastener can be provided in many variants: with different limb lengths, shapes, and for different plate thicknesses.

FIG. 2 shows the principle structure of a fastening element 13 of this type. A planar base 20 serves as support and, in the installed state, transfers the retaining forces to the clip. The two protrusions 14 and 15 serve for the fixing in the clip and also as torque supports. The cylindrical portion 19 forms the receptacle for the fastener.

Here, the fastening element 13 can be embodied in many variants: as a detachable or non-detachable latching connection having one fixed latched position or a number of latched positions. The cylindrical portion 19 can also have an internal thread for a screw. A screw connection here has the advantage of being detachable and offers the possibility of being able to control the tightening torque.

The fastening element can be manufactured from metal or plastic depending on the use profile. If high strengths are required, metal is preferred, but poses a challenge for production. Very high production costs must be anticipated for turned/milled parts. In a multi-stage shaping process, a fastening element can also be manufactured from wire, strip material, or sheet material, but in this case also passes through multiple processes and might then have to be subjected to a heat treatment.

### SUMMARY

The objective of the present invention is to mitigate the above-mentioned disadvantages of the prior art and in particular present a lightweight fastening element of simple manufacture. This is achieved with a lightweight fastener of this type having one or more features of the invention. Various useful embodiments and enhancements are described below and in the claims.

In principle it is proposed to use a wire nut or threaded wire nut instead of the fastening element formed in a complex manner from shaped or machined material. In a preferred embodiment the wire nut has shoulders formed continuously from wire, which shoulders take on the function of torque supports.

Speaking generally, the invention describes a lightweight fastener comprising a thread body with at least one torque support, and also a housing, which receives the thread body at least in part and has a counter support for the at least one torque support and uses a wire nut or threaded wire nut as thread body.

### BRIEF DESCRIPTION OF THE DRAWINGS

Hereinafter, the threaded wire nut and the possible uses thereof will be explained in the context of the invention with reference to the drawings. In the drawings:

FIGS. 1 and 2 describe the prior art of clip fastenings formed of a clip body 10 which has two limbs 11, 12 which can be slid over a plate 18. The opening of the fastening element 13 is positioned above a slot provided in the plate 18. The fastening element 13 is produced in the prior art as a shaped or machined or assembled part.

FIG. 3 shows a threaded wire nut in accordance with an embodiment of the invention.

FIGS. 4 and 5 show threaded wire nuts in accordance with inventive embodiments in cross-section.

FIG. 6 shows an insert which has a threaded wire nut 61 instead of a conventional nut element.

### DETAILED DESCRIPTION OF THE PREFERRED EMBODIMENTS

The features and preferences described for the fastening element and the wire nut or threaded wire nut thus apply directly and analogously for the light-weight fastener. This lightweight fastener can be used in many variants. The description below relates primarily to inserts or clips in the form of two known application examples. These are not intended to be limiting, however, and the applicability of a lightweight fastener is not limited to these designs.

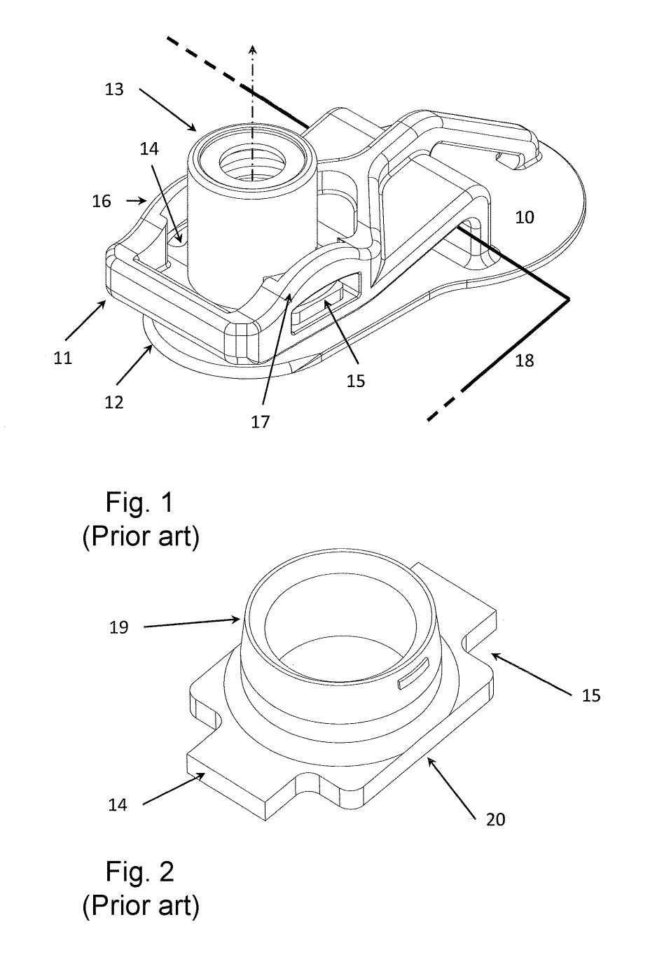

FIG. 1 shows a clip with a clip body 10 with two limbs 11, 12 for fitting/sliding onto a plate 18, wherein one of the limbs has a receiver for the fastening element 13, which is in turn designed to receive a fastener. The fastening element 13 has a wire nut or a threaded wire nut 30. The receiver or the counter support for the torque supports are in this case constituted by frames or cages 16, 17, as shown in FIG. 1, or functionally equivalent devices such as retaining brackets, eyelets, or the like. The cage 16, 17 thus corresponds functionally to the housing of the light-weight fastener, or the lightweight fastener is part of one of the limbs of the clip body.

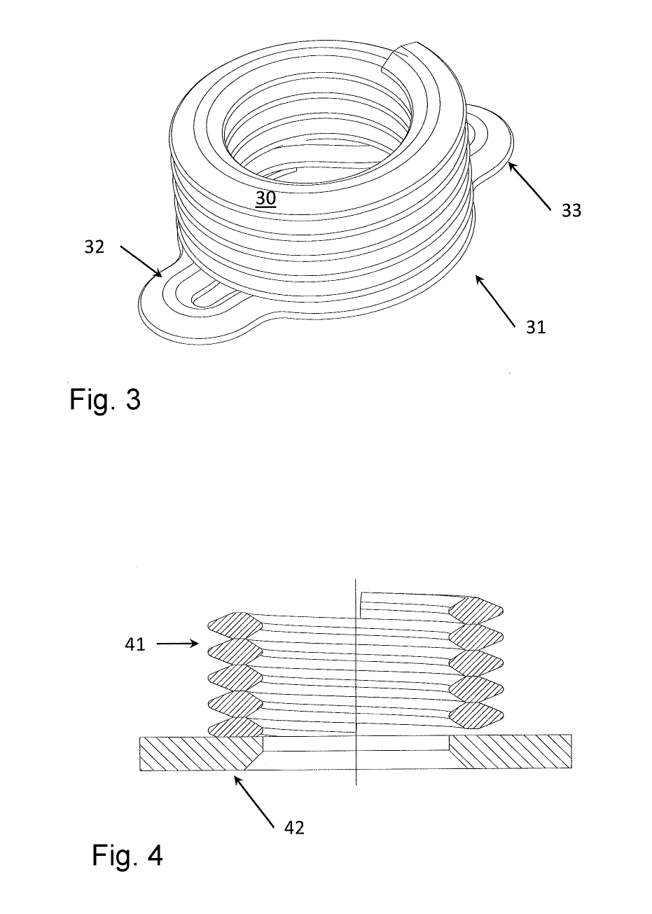

FIG. 3 shows a wire nut or threaded wire nut 30 formed in accordance with the invention. It includes a thread part 31 wound in a spiral from wire and also of two wings 32, 33, which are moulded from the wire spirals and which are formed by means of loops from wire. These loops take on the function of the torque supports. The wire preferably has an angular cross-sectional profile, which, in the thread part wound in a spiralled manner, results in the formation of thread flanks and thread tips. As shown in FIG. 3, the wire can have a preferably approximately diamond-shaped cross-section with flattened edges, which improves the stability of the resultant threaded wire nut.

The number of wings 32, 33 formed by means of loops from wire can vary. If the demands on the torque transfer are greater, three wire loops 32 (for example offset by 120°) or four (for example each offset by 90°) can also be formed instead of two.

If the demands were less critical, it would also be conceivable to form just one loop 32 and to guide the wire nut at the rest of the periphery in the manner of a tubular mounting or short sleeve with radial play. The loop would protrude from the tube/sleeve for example through a cut-out, which also allows a unique orientation of the threaded wire nut.

The dimensioning of the wire and the angle when winding the wire nut defines the characteristic variables of the thread. As required, imperial or metric threads with different diameters and pitches can thus be produced. For design reasons, the wire is preferably designed such that the layers in the thread part 31 contact one another directly, preferably at the flattened edge regions of the diamond-shaped cross-section. The spring effect when screwing in a fastener can thus be set. A resilient screw lock allows a high number of screwing cycles and makes it possible to reduce the use of lubricating aids during assembly.

The length of such a thread can be designed differently, preferably such that a later fastener in the final installed state is fully surrounded and the retaining forces are thus optimised. The length of the thread can be controlled very precisely during production, thus optimising the material usage.

The turns of the threaded wire nut can be connected after the winding, for example by being welded, adhesively bonded or cast. Surface post-treatments are also possible, for example in the form of rust protection, in order to influence the sliding properties or to enhance the aesthetic properties.

Alternatively to a winding forming a round wire spiral, it is also possible to produce the wire windings with polygonal turns instead of round turns. This leads to an increased friction at one or more points over the periphery as a fastener is screwed in, and leads to a resiliently sprung frictional connection. A screw-clamping region thus increases the stability of the resultant connection.

FIG. 4 shows a simplified variant of a threaded wire nut 41 without integrally moulded torque supports or wings. It can be advantageous or necessary in terms of manufacture to mount a wire nut without these wings on a separate baseplate 42. The fastening can be provided by gluing, welding, soldering, or the like. This baseplate 42 can have lateral projections, similarly to the lug protrusions 14, 15 of FIG. 2.

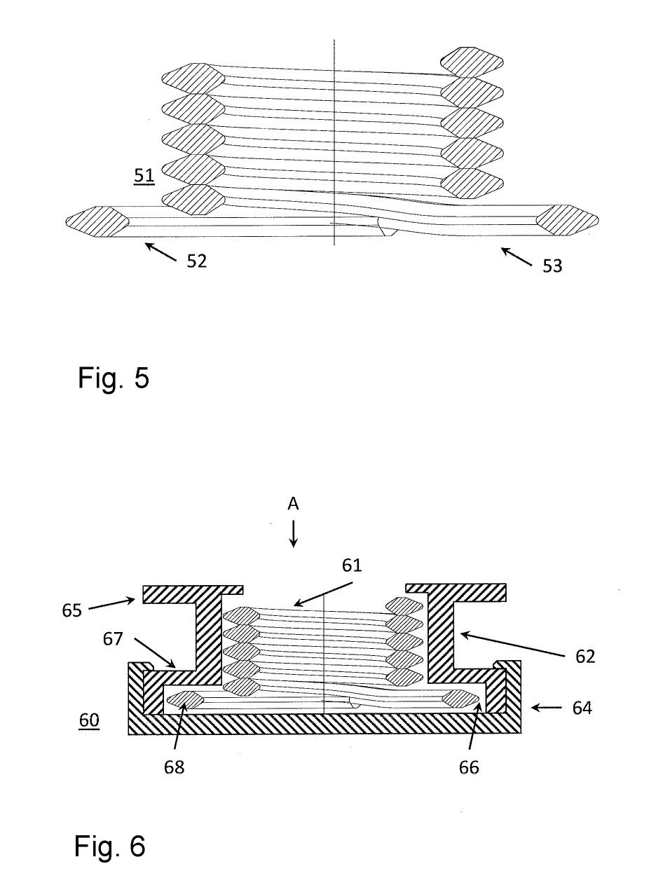

FIG. 5 shows a cross-section through a threaded wire nut according to the invention in accordance with FIG. 3 with projecting torque supports moulded integrally from wire. It can also be seen how the profiling of the wire influences the thread form. The advantage of this embodiment is that it can be provided in one piece in an accordingly designed manufacturing process. This reduces the number of raw parts, manufacturing steps and thus the costs, in particular where high volumes are to be produced. A design in the form of a threaded wire nut also provides a weight advantage compared to a component according to the prior art.

The production can be implemented similarly to the manufacture of threaded wire inserts, as are known in the prior art in the form of repair and thread reinforcement components.

FIG. 6 shows a further application from the field of vehicle construction or aircraft interior design: what is known as an insert or nut insert for a plate element or sandwich panel. What is shown by way of example is a housing of two-part design with an angular first part 62, which is substantially cylindrical with a first flange 65. A second housing part 64 comprises the part facing away from the flange 65, such as a surrounding cover. What is shown in FIG. 6 is a snap-fit closure, which allows a simple assembly of the insert, however other fixing possibilities are not ruled out either.

A threaded wire nut 61 is inserted into the first housing part 62 such that the above-described loops from integrally moulded, projecting torque supports, which have been formed continuously from the wire of the wire nut, rest on the second flange part 67. The second housing part 61 slid over forms an undercut in the insert 60 together with the second flange 67, which undercut securely holds the loops 68 in the manner of an annular groove 66. Means can also be provided in the second housing part 64 and also on the flange 67 so as to prevent a rotation of the threaded wire nut in the housing, said means thus performing the function of the torque supports.

The insert 60 is introduced into a blind bore in a sandwich panel and is adhesively bonded there, for example. A fastening element, such as a screw, is later introduced into the insert in the direction A.

Since, on account of its design, the wire nut can be formed narrower than a deep-drawn or turned nut body, the housing of the insert can be made smaller whilst maintaining the same functionality. The thread can be manufactured to exact specifications due to the wound structure, thus utilising the available installation height optimally.

### LIST OF REFERENCE SIGNS

10 clip body

11 first limb

12 second limb

13 fastening element

14, 15 lug protrusions

16, 17 cage or frame

18 plate

19 cylindrical portion

20 planar base

30 wire nut or threaded wire nut

31 thread part

32, 33 wing

41 threaded wire nut

42 baseplate

51 threaded wire nut

52, 53 wire loop(s)

60 insert

61 threaded wire nut

62 first housing part

64 second housing part

65 flange

66 annular groove

67 (second) flange

68 wire loop

1. A lightweight fastener comprising:
a threaded body formed as a wire nut or threaded wire nut with at least one torque support, and
a housing, which receives the threaded body at least in part, and a counter support for the at least one torque support.

2. The lightweight fastener according to claim 1, wherein a thread of the wire nut is constructed from an angularly profiled wire, a dimensioning of which defines thread measurements.

3. The lightweight fastener according to claim 1, wherein the housing is formed substantially as a tube, sleeve, frame, or cage.

4. The lightweight fastener according to claim 1, wherein the wire nut is surface-treated following manufacture.

5. The lightweight fastener according to claim 1, wherein a thread of the wire nut has wire windings with turns shaped in a polygonal manner in cross-section.

6. The lightweight fastener according to claim 1, wherein an attachment is provided on the housing in order to mount the fastener to a planar lightweight construction element.

7. The lightweight fastener according to claim 6, wherein the threaded body is fastened to a planar baseplate (42) and said baseplate comprises the at least one torque support formed as a lateral projection or cut-out which cooperates with the counter support in the housing.

8. The lightweight fastener according to claim 6, wherein the at least one torque support is formed as a projecting wire loop (52, 53) integrally moulded on the wire nut (51), said wire loop is formed continuously from the wire of the wire nut (51).

9. The lightweight fastener according to claim 8, wherein the lightweight fastener is part of a clip with a clip body (10), and an attachment on the housing is formed by two limbs (11, 12) for fitting/sliding onto a plate (18).

10. The lightweight fastener according to claim 8, wherein the lightweight fastener is part of an insert (60) which can be anchored by said housing (62, 64) in a pre-drilled blind bore of a sandwich panel.

11. The lightweight fastener according to claim 7, wherein the lightweight fastener is part of a clip with a clip body (10), and an attachment on the housing is formed by two limbs (11, 12) for fitting/sliding onto a plate (18).

12. The lightweight fastener according to claim 7, wherein the lightweight fastener is part of an insert (60) which can be anchored by said housing (62, 64) in a pre-drilled blind bore of a sandwich panel.
